(19) United States
(12) Patent Application Publication
(10) Pub. No.: US 2017/0120464 A1
(43) Pub. Date: May 4, 2017

(54) HAND CUTTING TOOL

(71) Applicant: MILWAUKEE ELECTRIC TOOL CORPORATION, Brookfield, WI (US)

(72) Inventors: Christopher S. Hoppe, Milwaukee, WI (US); Steven W. Hyma, Milwaukee, WI (US); Kyle Reeder, Pewaukee, WI (US); Mark W. Cors, St. Francis, WI (US)

(21) Appl. No.: 15/343,297

(22) Filed: Nov. 4, 2016

Related U.S. Application Data
(60) Provisional application No. 62/251,329, filed on Nov. 5, 2015.
(60) Provisional application No. 62/251,080, filed on Nov. 4, 2015.

(51) Int. Cl. B26B 13/16; B23D 29/02

(52) U.S. Cl. CPC B26B 13/16; B23D 29/026

(57) ABSTRACT

A hand cutting tool including a first cutting blade, a second cutting blade, a first handle, and a second handle. The hand cutting tool further includes a handle lock assembly configured to retain the cutting tool in a closed position. The hand cutting tool further includes a visual indicator disposed on at least one of the first handle and the second handle to identify the type of cutting tool and a tactile indicator disposed on at least one of the first handle and the second handle to identify the type of cutting tool.

### CROSS-REFERENCE TO RELATED APPLICATIONS

This application claims priority to co-pending, prior-filed U.S. Provisional Patent Application No. 62/251,080, filed Nov. 4, 2015 and U.S. Provisional Patent Application No. 62/251,329, filed Nov. 5, 2015. The entire contents of both applications are incorporated by reference.

### BACKGROUND

The present invention relates to a hand tool, such as a hand cutting tool including tin snips or aviation snips.

Tin snips, also referred to as aviation snips, metal snips, or tinners, are a category of tools used to cut metal workpieces by a shearing action. Tin snips are used for a variety of tasks in manufacturing and building constructions. Tin snips often have a variety of different oriented cutting blades to perform various cutting operations. The task of determining the orientation of the cutting blades between the various tin snips is typically accomplished by removing the tin snips from the user's pocket, tool box, or bag and examining the cutting blades. This task can be cumbersome and time consuming to remove and examine each type of tin snip to find the desired tin snip.

### SUMMARY

In one embodiment the invention provides a hand cutting tool including a first cutting blade, a second cutting blade, a first handle, a second handle, and a handle lock assembly configured to retain the cutting tool in a closed position. The hand cutting tool further includes a visual indicator disposed on at least one of the first handle and the second handle to identify the type of cutting tool and a tactile indicator disposed on at least one of the first handle and the second handle to identify the type of cutting tool.

In another embodiment the invention provides a hand cutting tool kit including a first cutting tool including a first cutting blade, a second cutting blade, a first handle having a first face and a second face opposite the first face, and a second handle having a first face and a second face opposite the first face. The first cutting tool further includes a first visual indicator disposed on at least one of the first handle and the second handle for identifying the first cutting tool and a first tactile indicator disposed on at least one of the first handle and the second handle for identifying the first cutting tool. The hand cutting tool kit further includes a second cutting tool including a first cutting blade, a second cutting blade, a first handle having a first face and a second face opposite the first face, and a second handle having a first face and a second face opposite the first face. The second cutting tool further includes a second visual indicator disposed on at least one of the first handle and the second handle for identifying the second cutting tool and a second tactile indicator disposed on at least one of the first handle and the second handle for identifying the second cutting tool. The hand cutting tool kit further includes a third cutting tool including a first cutting blade, a second cutting blade, a first handle having a first face and a second face opposite the first face, and a second handle having a first face and a second face opposite the first face. The third cutting tool further includes a third visual indicator disposed on at least one of the first handle and the second handle for identifying the third cutting tool and a third tactile indicator disposed on at least one of the first handle and the second handle for identifying the third cutting tool.

In another embodiment the invention provides a hand cutting tool including a first cutting blade, a second cutting blade, a first handle for driving movement of the second cutting blade, and a second handle for driving movement of the first cutting blade. The first handle has a first face and a second face opposite the first face. The second handle has a first face and a second face opposite the first face. The hand cutting tool further includes a handle lock assembly configured to retain the cutting tool in a closed position. The hand cutting tool further includes a tactile indicator having a tactile member disposed on one of the first face and the second face of the first handle.

### BRIEF DESCRIPTION OF THE DRAWINGS

FIG. 1 is a side view of a hand cutting tool according to an embodiment of the invention.

FIG. 2 is an enlarged perspective view of a portion of the hand cutting tool, illustrating a visual indicator of the type of cutting tool.

FIG. 3 is a top view of the hand cutting tool of FIG. 1.

FIG. 4 is an enlarged side view of a portion of the hand cutting tool, illustrating a handle lock assembly.

FIG. 5 is a side view of a portion of a hand cutting tool according to another embodiment of the invention.

FIG. 6 is a side view of a hand cutting tool according to another embodiment of the invention.

FIG. 7 is an enlarged perspective view of a portion of the hand cutting tool of FIG. 6, illustrating a visual indicator and tactile indicator of the type of cutting tool.

FIG. 8 is a side view of a hand cutting tool according to yet another embodiment of the invention.

FIG. 9 is an enlarged perspective view of a portion of the hand cutting tool of FIG. 8, illustrating a visual indicator and tactile indicator of the type of cutting tool.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

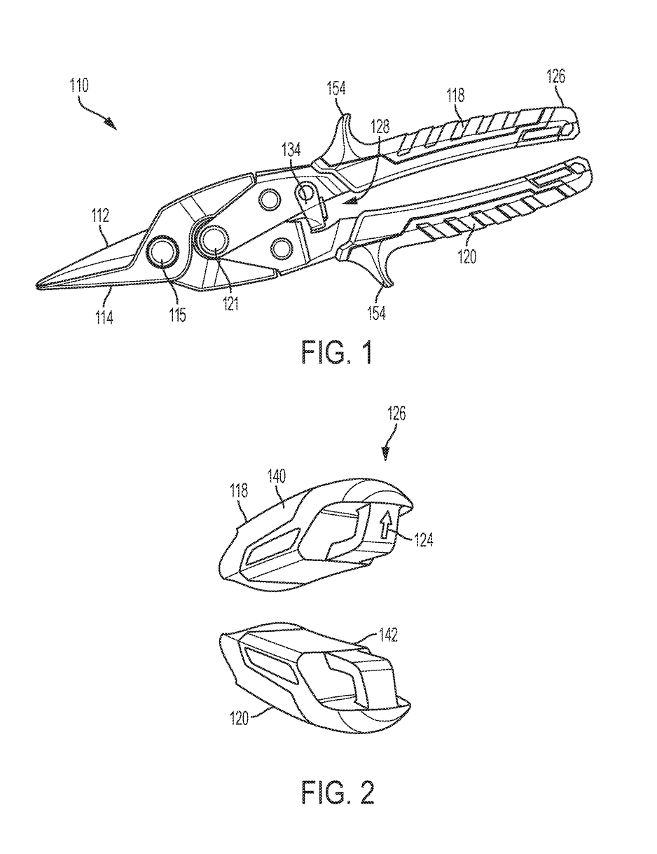

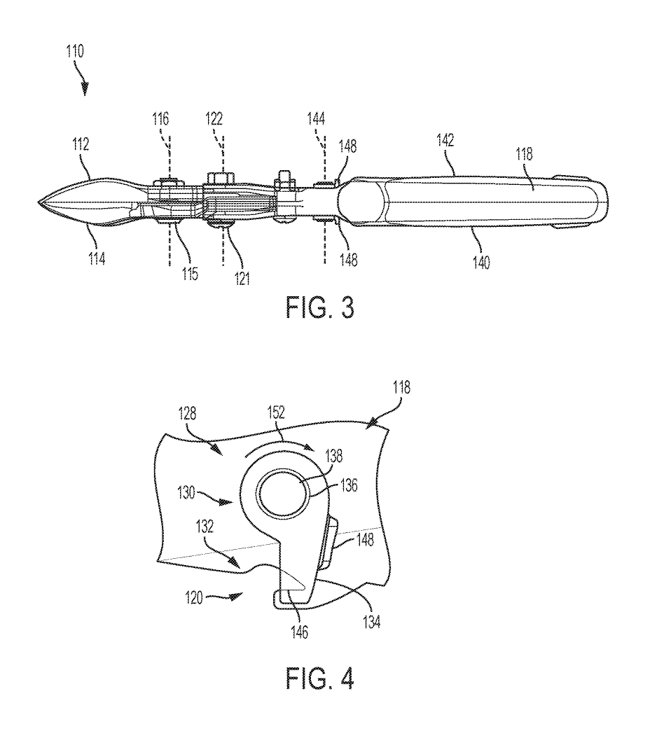

FIG. 1 illustrates a hand cutting tool 110. In the illustrated embodiment, the hand cutting tool 110 is a tin snips or aviation snips. In other embodiments, the hand cutting tool can include other types of hand cutting tools, such as wire cutters, shears, etc. The snips 110 includes a first or upper blade 112 and a second or lower blade 114. The upper blade 112 and the lower blade 114 pivot with respect to each other about a first pivot joint 115 defining a pivot axis 116 (FIG. 3). A first or upper handle 118 is coupled to the lower blade 114 and a second or lower handle 120 is coupled to the upper blade 112. The handles 118, 120 pivot with respect to each other about a second pivot joint 121 defining a pivot axis 122 (FIG. 3) in order to pivot the blades 112 and 114 relative to each other about the pivot axis 116 and operate the snips 110.

The snips 110 of the illustrated embodiment in FIG. 1 are of a center-type configuration such that the snips 110 facilitate at least one of a straight, a large radius, and a slight turn cutting operation. As shown in FIG. 2, the snips 110 include an indicia (e.g., a straight arrow indicia 124) disposed at a distal end 126 of the upper handle 118. The straight arrow indicia 124 provides a visual indication to an operator that the snips 110 are of the center-type configuration. The snips 110 may include one or more tactile indicators (e.g., a bump, an embossed lug, etc.) in order to provide tactile indication to an operator that the snips 110 are of the center-type configuration. In the illustrated embodiment, the tactile indicator of the snips 110 is a flat or smooth surface that does not include a bump or protrusion. As such, an operator is able to differentiate the snips 110 of the center-type configuration compared to other configuration types that have tactile indicators, as described below. Even though the illustrated embodiment of the indicia is a straight arrow 124 disposed at the distal end 126 of the upper handle 118, in other embodiments, the indicia may represent an alternative symbol and be located elsewhere on the snips 110. In some embodiments, the snips 110 are provided with a color for indicating that the snips 110 are of the center-type configuration.

Furthermore, the handles 118, 120 each include a horn 154 extending outwardly from the handles 118, 120. More specifically, each horn 154 is angled back toward the operator's hand and away from the blades 112, 114. Thus, when the snips 110 are in being used, the horns 154 prevent the operator's hand from slipping forward toward the blades 112, 114 and the cutting area.

Referring to FIG. 4, the snips 110 further includes a handle lock assembly 128 that retains the handles 118, 120 in a closed position (FIG. 1). In the illustrated embodiment, the handles 118, 120 are spring biased toward an open position and the handle lock assembly 128 inhibits the handles 118, 120 from moving toward the open position where the blades 112, 114 would also be opened.

With continued reference to FIG. 4, the handle lock assembly 128 includes a first latch member 130 and a second latch member 132 onto which the first latch member 130 hooks or latches to retain the handles 118, 120 in the closed position. The first latch member 130 includes a latch 134 and an aperture 136. A pin 138, which is formed by a rivet in the illustrated embodiment, extends through opposing sides 140, 142 (FIG. 3) of the handle 118 and the aperture 136. The pin 138 couples the first latch member 130 to the handle 118 for rotation with respect to the handle 118 about an axis 144, as shown in FIG. 3. Furthermore, the latch 134 includes an actuator 148, which is formed as a protrusion that is integrally formed with the latch 134 as a single component in the illustrated embodiment. The actuator 148 provides a gasping region to facilitate an operator in moving the latch 134, typically with one of the operator's fingers. The second latch member 132 includes a hook 146 that engages the latch 134 of the first latch member 130. As shown in the illustrated embodiment of FIG. 4, the hook 146 is integrally formed with the lower handle 120. For example, the handles 118, 120 are formed by stamping and the hook 146 is formed using the same metal stamping as the handle 120. In some embodiments, the second latch member 132 may alternatively be coupled to the handle 120 while the first latch member 132 is integrally formed with the handle 118.

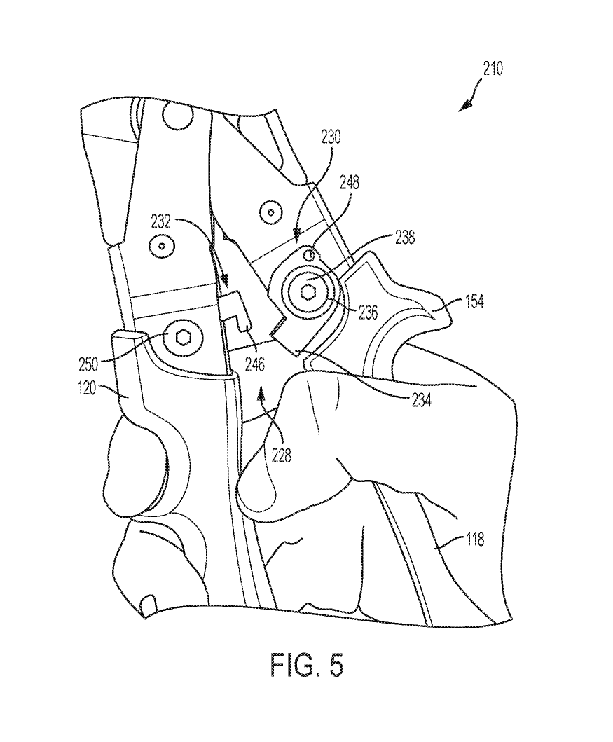

FIG. 5 illustrates a snips 210 having a handle lock assembly 228 according to another embodiment. The snips 210 are similar to the snips 110 described above with reference to FIGS. 1-4, and similar parts have been given the same reference number plus 100. Only differences between the embodiments are described.

As shown in FIG. 5, the handle lock assembly 228 includes a first latch member 230 and a second latch member 232. Similarly, the first latch member 230 includes a latch 234 and an aperture 236, in which a pin 238 couples the latch 234 to the handle 218 for rotation with respect to the handle 218 about the axis 144. Furthermore, the latch 234 includes an actuator 248, which is formed as a protrusion that is integrally formed with the latch 234 to assist an operator to move the latch 234, typically with one of the operator's fingers. In the illustrated embodiment of the FIG. 5, the second latch member 232 includes a hook 246 that is formed as a separate component from the handle 220. As such, a pin 250 secures the hook 246 to the handle 220.

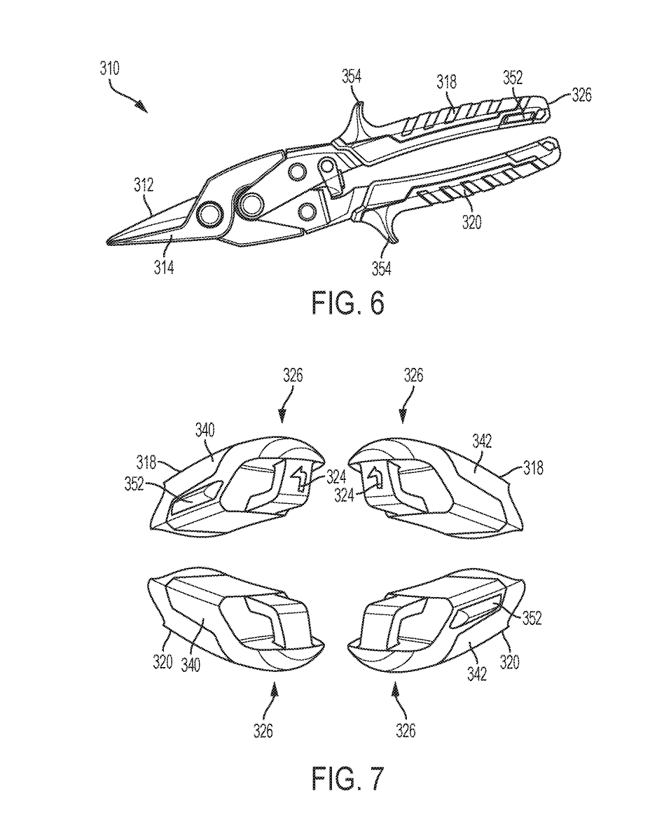

FIGS. 6-7 illustrate a hand cutting tool 310, such as a tin snips or aviation snips according to another embodiment. The snips 310 are similar to the snips 110 described above with reference to FIGS. 1-4, and similar parts have been give the same reference number plus 200. Only differences between the embodiments are described.

As shown in FIGS. 6-7, the snips 310 of the illustrated embodiment are of a left-type configuration such that the snips 310 facilitate left curve cutting operations. As shown in FIG. 7, the snips 310 include an indicia (e.g., a left arrow indicia 324) disposed at a distal end 326 of the upper handle 318. The left arrow indicia 324 provides a visual indication to an operator that the snips 310 are of the left-type configuration. Furthermore, the snips 310 includes a tactile indicator, such as a pair of bumps 352 (or a similar embossed lug) in order to provide tactile indication to an operator that the snips 310 are of the left-type configuration. As illustrated in FIG. 7, one of the bumps 352 is disposed on the opposing side 340, and in particular a left side, near a distal end 326 of the handle 318, whereas the other one of the bumps 352 is disposed on the opposing side 342, and in particular a right side, near a distal end 326 of the handle 320. In some embodiments, the snips 310 are provided with a color that is different than the color of the snips 110 for indicating that the snips 310 are of the left-type configuration.

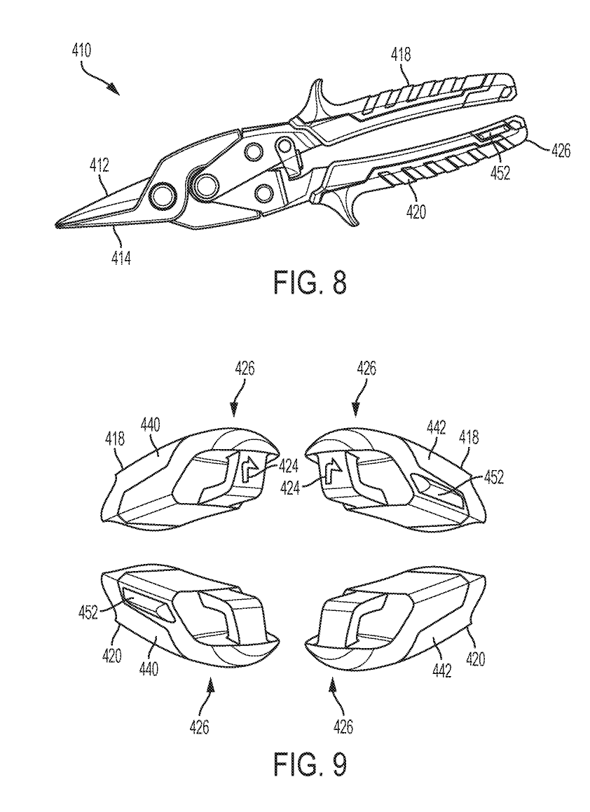

FIGS. 8-9 illustrate a hand cutting tool 410, such as a tin snips or aviation snips according to another embodiment. The snips 410 are similar to the snips 110 described above with reference to FIGS. 1-4, and similar parts have been give the same reference number plus 300. Only differences between the embodiments are described.

As shown in FIGS. 8-9, the snips 410 of the illustrated embodiment are of a right-type configuration such that the snips 410 facilitate right curve cutting operations. As shown in FIG. 9, the snips 410 include an indicia (e.g., a right arrow indicia 424) disposed at a distal end 426 of the upper handle 418. The right arrow indicia 424 provides a visual indication to an operator that the snips 410 are of the right-type configuration. Furthermore, the snips 410 includes a tactile indicator, such as a pair of bumps 452 (or a similar embossed lug) in order to provide tactile indication to an operator that the snips 410 are of the right-type configuration. As illustrated in FIG. 9, one of the bumps 452 is disposed on the opposing side 442, and in particular a right side, near a distal end 426 of the handle 418, whereas the other one of the bumps 452 is disposed on the opposing side 440, and in particular a left side, near a distal end 426 of the handle 418. In some embodiments, the snips 410 are provided with a color that is different than the color of the snips 110, 310 for indicating that the snips 410 are of the right-type configuration.

The snips 110 (or 210), 310, 410 may be incorporated into a kit, and sold as a group rather than individually. Further, within the kit, the visual and tactile indicators can be used in order to compare one of the snips (e.g., snips 110) in the kit to a different one of the snips (e.g., 310 and 410). Further, the bumps 352, 452 allow a user to identify which snips 110, 310, 410 they are grabbing irrespective of the orientation of the snips 110, 310, 410 in a tool holder, pocket, or other container, as described in further detail below. Although the illustrated embodiments of the visual and tactile indicators are shown in specific arrangements and locations, in other embodiments, visual and tactile indicators may be arranged differently and located elsewhere on the snips.

In operation, snips 110, 310, 410 are operated in a similar manner. As such, only the operation of snips 110 will be described for sake of brevity. Referring to FIG. 1, an operator grabs or grips the upper handle 118 and the lower handle 120 and pivots the handles 118, 120 with respect to each other about pivot axis 122 in order to pivot the blades 112, 114 about the pivot axis 116 to cut a work-piece. After using the snips 110, the operator may desire to lock the handles 118, 120, which are spring biased to the open position, in the closed position (FIG. 1) so that the handles 118, 120 do not open when the snips 110 is in the operator tool belt or the like. To lock the handles 118, 120 the operator moves the lock assembly 128 to a latched position (FIG. 4). In some embodiments, to move the lock assembly 128 from an unlatched position (FIG. 5) to the latched position (FIG. 4), the operator uses the actuator 148 to pivot the latch 134 about the axis 144 in the direction of arrow 152 (FIG. 4).

When grabbing the handles 118, 120 (or 318, 320; 418, 420) of the snips 110, 310, 410, an operator can identify the type of configuration (i.e. center, left, right) of the snips 110, 310, 410 without having to look at the snips 110, 310, 410. More specifically, an operator simply identifies the snips 110, 310, 410 based on whether the snips 110, 310, 410 contain a tactile indicator (e.g., a bump 352, 452) located on one opposing side 140, the other opposing side 142, or contains no bumps at all on either opposing side 140, 142. Alternatively, an operator may identify the type of snips 110, 310, 410 based on the indicia (e.g., the center arrow, the left arrow, the right arrow) disposed on the handle 118, 318, 418.

The tactile indicators advantageously permit an operator to store the snips in an enclosure (e.g., a pocket, a tool bag, a tool belt, etc.) without having to remove each set of snips 110, 310, 410 from the enclosure to identify the type of snips. More specifically, the bumps 352, 452 allow a user to recognize and distinguish which snips 110, 310, 410 they are grabbing regardless of which orientation the snips 110, 310, 410 are stored. For example, if a user grabs a snips and the bump is located on the left side of the upper handle based on the snips current orientation, the user will know it is a left-type snips. Similarly, for a right-type snips, when a user grabs a snips, the bump will be located on the right side of the upper handle, based on the snips current orientation.

By angling each horn 154 back toward the user's hand, the horns 154 are oriented in a substantially vertical position even when the handles 118, 120 are in the open position. As such, the operator's hand is inhibited from slipping forward during a cutting operation.

Although the invention has been described in detail with reference to certain preferred embodiments, variations and modifications exist within the scope and spirit of one or more independent aspects of the invention as described. Various features of the invention are set forth in the following claims.

What is claimed is:

1. A hand cutting tool comprising:
a first cutting blade;
a second cutting blade;
a first handle;
a second handle;
a handle lock assembly configured to retain the cutting tool in a closed position; and
a visual indicator on at least one of the first handle and the second handle to identify the type of cutting tool; and
a tactile indicator disposed on at least one of the first handle and the second handle to identify the type of cutting tool.

2. The hand cutting tool of claim 1, wherein the first and second handles are spring biased toward an open position.

3. The hand cutting tool of claim 1, wherein the handle lock assembly includes a first latch member coupled to the first handle and a second latch member coupled to the second handle, wherein the first latch member includes a latch pivotably coupled to the first handle and the second latch member includes a hook that is engageable with the latch and coupled to the second handle.

4. The hand cutting tool of claim 3, wherein the handle lock assembly is moveable between a first position and a second position, wherein the latch is engageable with the hook in the first position thereby configuring the cutting tool in the closed position, and the latch is unengageable with the hook in the second position thereby configuring the cutting tool in an open position.

5. The hand cutting tool of claim 1, wherein the visual indicator is disposed at a distal end of the first handle.

6. The hand cutting tool of claim 1, wherein the first and second handle each include a first face and a second face opposite the first face, wherein the tactile indicator includes a first tactile member disposed on a first face of the first handle and a second tactile member disposed on a second face of the second handle.

7. The hand cutting tool of claim 1, wherein the tactile indicator is an embossed lug that protrudes away from a surface of the at least one of the first and second handle.

8. A hand cutting tool kit comprising:
a first cutting tool including
a first cutting blade,
a second cutting blade,
a first handle having a first face and a second face opposite the first face,
a second handle having a first face and a second face opposite the first face, and
a first visual indicator disposed on at least one of the first handle and the second handle for identifying the first cutting tool; and
a first tactile indicator disposed on at least one of the first handle and the second handle for identifying the first cutting tool;
a second cutting tool including
a first cutting blade,
a second cutting blade,
a first handle having a first face and a second face opposite the first face,
a second handle having a first face and a second face opposite the first face, and
a second visual indicator disposed on at least one of the first handle and the second handle for identifying the second cutting tool; and
a second tactile indicator disposed on at least one of the first handle and the second handle for identifying the second cutting tool; and
a third cutting tool including
a first cutting blade,
a second cutting blade,
a first handle having a first face and a second face opposite the first face,
a second handle having a first face and a second face opposite the first face, and
a third visual indicator disposed on at least one of the first handle and the second handle for identifying the third cutting tool; and
a third tactile indicator disposed on at least one of the first handle and the second handle for identifying the third cutting tool.

9. The hand cutting kit of claim 8, wherein the first tactile indicator is a flat surface.

10. The hand cutting kit of claim 8, wherein the second tactile indicator includes a first tactile member disposed on the first face of the first handle and a second tactile member disposed on the second face of the second handle of the second cutting tool.

11. The hand cutting kit of claim 8, wherein the third tactile indicator includes a first tactile member disposed on the second face of the first handle and a second tactile member disposed on the first face of the second handle of the third cutting tool.

12. The hand cutting kit of claim 8, wherein the first visual indicator is a straight arrow indicia, wherein the second visual indicator is a left arrow indicia, and wherein the third indicator is a right arrow indicia.

13. The hand cutting kit of claim 8, wherein the first cutting tool is configured for straight cutting operations, wherein the second cutting tool is configured for left-turning cutting operations, and wherein the third cutting tool is configured for right-turning cutting operations.

14. The hand cutting kit of claim 8, wherein each cutting tool includes a handle lock assembly configured to maintain each cutting tool in a closed position, and wherein the first and second handles of each cutting tool are spring biased toward an open position.

15. A hand cutting tool comprising:
a first cutting blade;
a second cutting blade;
a first handle for driving movement of the second cutting blade, the first handle has a first face and a second face opposite the first face;
a second handle for driving movement of the first cutting blade, the second handle has a first face and a second face opposite the first face;
a handle lock assembly configured to retain the cutting tool in a closed position; and
a tactile indicator having a tactile member disposed on one of the first face and the second face of the first handle.

16. The hand cutting tool of claim 15, wherein the tactile member is a smooth surface.

17. The hand cutting tool of claim 15, wherein the tactile member is an embossed lug extending away from a surface of the first handle.

18. The hand cutting tool of claim 15, wherein the tactile member is a first tactile member disposed on the first face of the first handle and the tactile indicator further includes a second tactile member disposed on the second face of the second handle.

19. The hand cutting tool of claim 15, wherein the tactile member is a first tactile member disposed on the second face of the second handle and the tactile indicator further includes a second tactile member disposed on the first face of the second handle.

20. The hand cutting tool of claim 15, further comprising a visual indicator disposed on at least one of the first handle and the second handle for identifying the third cutting tool, wherein the visual indicator is one of a straight arrow indicia, a left arrow indicia, and a right arrow indicia.
